(19) United States
(12) Patent Application Publication
(10) Pub. No.: US 2019/0177192 A1
(43) Pub. Date: Jun. 13, 2019

(54) METHOD FOR REMOVING PHOSPHORUS COMPOUNDS FROM AN AQUEOUS MEDIUM

(71) Applicant: REGENTS OF THE UNIVERSITY OF MINNESOTA, MINNEAPOLIS, MN (US)

(72) Inventors: Kenneth J. Valentas, Golden Valley, MN (US); Scott Plewka, St. Paul, MN (US); Zachary Pursell, Minneapolis, MN (US); Gabriel Gerner, St. Paul, MN (US); Kathleen Hall, St. Paul, MN (US)

(21) Appl. No.: 16/216,278

(22) Filed: Dec. 11, 2018

Related U.S. Application Data
(60) Provisional application No. 62/597,031, filed on Dec. 11, 2017.
(60) Provisional application No. 62/718,705, filed on Aug. 14, 2018.

(51) Int. Cl. C02F 1/52; C02F 1/02

(52) U.S. Cl. CPC C02F 1/5236; C07F 9/3813; C02F 1/02

(57) ABSTRACT

The present disclosure provides a method for removing a phosphorus compound from an aqueous medium. In one embodiment, the method includes: providing a rare-earth metal-modified carrier; and contacting the rare-earth metal-modified carrier with an aqueous medium including the phosphorus compound under conditions effective to remove at least a portion of the phosphorus compound from the aqueous medium.

### PRIORITY

This application claims priority to United States Provisional Application Nos. 62/597,031 filed on Dec. 11, 2017 entitled “METHOD FOR REMOVING AN ORGANOPHOSPHORUS COMPOUND FROM AN AQUEOUS MEDIUM” and 62/718,705 filed on Aug. 14, 2018 entitled “METHOD FOR REMOVING PHOSPHORUS COMPOUNDS FROM AN AQUEOUS MEDIUM”, the disclosures of which are incorporated herein by reference thereto.

### BACKGROUND

The negative effects of high phosphorus concentration are known. Phosphorus is a naturally occurring nutrient that is essential for terrestrial and aquatic plant growth. In freshwater ecosystems, phosphorus is generally the nutrient limiting plant growth. However, due to human activities, phosphorus concentrations in affected aquatic ecosystems are so high that phosphorus is no longer limiting and the system is no longer in balance (a process known as eutrophication). This results in algal blooms and excessive aquatic plant growth that negatively impact the aquatic community when these blooms die and decompose. During the decomposition process, microbes consume dissolved oxygen. This creates a stressful or deadly low oxygen (anoxic) environment for the biotic community, including macroinvertebrates and fish.

Agricultural activities are a significant contributor to the problem of excess phosphorus concentration in lakes and river. Glyphosate is a specific type of phosphorus compound, an organophosphorus compound, which is used as a non-selective herbicide in agriculture. Concern about glyphosate has been increasing, especially in view of recent reports that glyphosate may be carcinogenic to humans. Better methods of removing phosphorus from runoff are needed, especially for removing excess phosphorus from drain tile and agricultural runoff water before it travels to water resources.

### SUMMARY

Disclosed herein are methods for removing phosphorus compounds from water using rare-earth metal-modified carriers (e.g., rare-earth metal-modified hydrochars, biochars or bio-hydrochars). The rare-earth metal-modified carriers can be used, for example, as a filter when water is transported from fields to water resources, for example, through drain-tiles.

Also disclosed herein are methods of removing a specific type of phosphorus compounds, organophosphorus compounds such as glyphosate from water using rare-earth metal-modified carriers (e.g., rare-earth metal-modified hydrochars, biochars or bio-hydrochars).

Biochars can be produced from the pyrolysis of low cost biomass, by drying and then heating the biomass to a very high temperature. Hydrochars can also be produced from low cost biomass, however in this case the biomass is processed with water in a high pressure reactor with minimal expenditure of energy. Bio-hydrochars can also be produced from biomass. There are two steps required to make bio-hydrochars from biomass feedstock. First the biomass is loaded into a reactor, a steel vessel that can withstand high pressure and temperature, and undergoes hydrothermal carbonization (HTC) which produces two product streams: a carbon dense solid called hydrochar, and a liquid stream which contains most of the phosphorus (except in the case of swine manure processing). The second step is to subject the hydrochar to a high temperature thermal treatment, in the absence of oxygen, to open the structure of the material and form a bio-hydrochar.

In one aspect, the present disclosure provides a method for removing a phosphorus compound from an aqueous medium. In one embodiment, the method includes: providing a rare-earth metal-modified carrier; and contacting the rare-earth metal-modified carrier with an aqueous medium including the phosphorus compound under conditions effective to remove at least a portion of the phosphorus compound from the aqueous medium.

In another aspect, the present disclosure provides a method for removing an organophosphorus compound from an aqueous medium. In one embodiment, the method includes: providing a rare-earth metal-modified carrier; and contacting the rare-earth metal-modified carrier with an aqueous medium including the organophosphorus compound under conditions effective to remove at least a portion of the organophosphorus compound from the aqueous medium.

In some embodiments, the methods disclosed herein can advantageously have the potential to protect water resources from two separate problems simultaneously: the contamination of ground water by phosphorus containing compounds (e.g., glyphosate (Roundup herbicide)) and the eutrophication of waters resulting from excess phosphorous.

As used herein, the term “organophosphorus” refers to a compound that contains both phosphorus and an organic (e.g., contains carbon) portion.

As used herein, the term “glyphosate” refers to (N-(phosphonomethyl)glycine), which is a commonly used broad-spectrum systemic herbicide and crop desiccant of the formula:

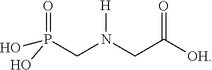

Glyphosate in solution may be partially or completely protonated, or may be in the form of salts and/or esters. Glyphosphate is a non-limiting example of an organophosphorus compound. As used herein “glyphosate” is intended to be broadly interpreted as including glyphosate, glyphosate derivatives, and/or salts thereof.

As used herein, the term “phosphate” refers to the anionic form of phosphoric acid having the formula PO₄³⁻. Phosphates in solution may be partially or completely protonated, or may be in the form of salts and/or esters. As used herein “phosphate” is intended to be broadly interpreted as including phosphoric acid and phosphoric acid derivatives and/or salts thereof. The term is also meant to include dehydrated forms of phosphoric acid such as polyphosphoric acid and phosphorus pentoxide.

As used herein, “sorbed” or “sorption” means the process in which one substance takes up or holds another via absorption or adsorption.

As used herein, “rare-earth metals” is meant to include the fifteen lanthanides, as well as scandium and yttrium. Thus, as used herein, the rare-earth metals include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y).

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above brief description of various embodiments of the present invention is not intended to describe each embodiment or every implementation of the present invention. Rather, a more complete understanding of the invention will become apparent and appreciated by reference to the following description and claims. Further, it is to be understood that other embodiments may be utilized and structural changes may be made without departing from the scope of the present invention.

### DETAILED DESCRIPTION OF ILLUSTRATIVE EMBODIMENTS

In one aspect, the present disclosure provides a method for removing a phosphorus containing compound from an aqueous medium. The phosphorus containing compound can include an organophosphorus compound, phosphate, or combinations thereof. In one embodiment, the method includes: providing a rare-earth metal-modified carrier; and contacting the rare-earth metal-modified carrier with an aqueous medium including the phosphorus compound under conditions effective to remove at least a portion of the phosphorus compound from the aqueous medium. In one embodiment, the phosphorus containing compound is a phosphonate. In certain embodiments, the phosphorus containing compound is a organophosphorus compound. In certain embodiments, the phosphorus containing compound is glyphosate. In certain embodiments, the phosphorus containing compound is a combination of phosphonate, phosphate, glyphosphate, or combinations thereof. In certain embodiments, the phosphorus containing compound is sorbed by the rare-earth metal-modified carrier.

For embodiments, in which the phosphorus compound is glyphosate, the aqueous medium can include prior to the contacting step, for example, 0.1 ppb to 10 ppm glyphosate.

Optionally, the aqueous medium can further include phosphate. For embodiments in which the aqueous medium further includes phosphate, the aqueous medium can include, prior to the contacting step, 0.1 ppm to 100 ppm phosphate.

In certain embodiments, the carrier of the rare-earth metal-modified carrier is a biochar, a hydrochar, a bio-hydrochar, or combinations thereof. Biochars can be produced from the pyrolysis of low cost biomass, by drying and then heating the biomass to a very high temperature. Hydrochars can also be produced from low cost biomass, however in this case the biomass is processed with water in a high pressure reactor with minimal expenditure of energy. A bio-hydrochar is the insoluble solid residue that is produced when a biomass is subjected to HTC then a high temperature thermal treatment in the absence of oxygen. As used herein, “HTC” or “hydrothermal carbonization” and “thermal hydrolysis” mean a process in which biomass and/or organic compounds are heated in water in a confined system. Hydrothermal carbonization (abbreviated as HTC) is differentiated from “liquefaction” and “gasification” processes that are conducted at substantially higher temperatures and pressures. For purposes of this disclosure, HTC processes are conducted from 185 to 250° C.

Illustrative methods of producing hydrochar are disclosed, for example, in U.S. Pat. No. 9,475,698 B2 (Heilmann et al.); and Dai et al., Bioresource Technology 161 (2014) 327-332.

In certain embodiments, the carrier of the rare-earth metal-modified carrier is a biochar. A biochar is the solid residue that is produced when a biomass is subjected to a thermochemical decomposition process in the presence of an inert atmosphere. Exemplary methods of producing biochar are disclosed, for example, in Wang et al., Chemosphere 119 (2015) 646-653; and Wang et al., Chemosphere 150 (2016) 1-7.

In certain embodiments, the rare-earth metal-modified carrier can be modified with one or more of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb) and yttrium (Y), for example. In some embodiments, the rare-earth metal-modified carrier can be modified with lanthanum.

In certain embodiments, the rare-earth metal-modified carrier can include, for example, 1 wt. % to 80 wt. % rare-earth metal, 5 wt. % to 60 wt. % rare-earth metal, or 10 wt. % to 40 wt. % rare-earth metal, based on the total dry solids weight of the carrier.

When the carrier of the rare-earth metal-modified carrier is a biochar, in one embodiment providing the rare-earth metal-modified biochar includes treating a biochar with a solution of a rare-earth metal salt and a hydroxide under conditions effective to produce the rare-earth metal-modified biochar. In certain embodiments, the rare-earth metal salt includes a rare-earth metal halide (e.g., a rare-earth metal chloride such as lanthanum chloride) and/or a rare-earth metal nitrate (e.g., lanthanum nitrate). In certain embodiments, the hydroxide can include sodium hydroxide and/or potassium hydroxide). Exemplary methods of producing rare-earth metal-modified biochar are disclosed, for example, in Wang et al., Chemosphere 119 (2015) 646-653; and Wang et al., Chemosphere 150 (2016) 1-7.

In one embodiment providing the rare-earth metal-modified bio-hydrochar includes treating a bio-hydrochar with a solution of a rare-earth metal salt and a hydroxide under conditions effective to produce the rare-earth metal-modified bio-hydrochar. In certain embodiments, the rare-earth metal salt includes a rare-earth metal halide (e.g., a rare-earth metal chloride such as lanthanum chloride) and/or a rare-earth metal nitrate (e.g., lanthanum nitrate). In certain embodiments, the hydroxide can include sodium hydroxide and/or potassium hydroxide).

The rare-earth metal-modified carrier can be contacted with an aqueous medium including the organophosphorus compound to remove at least a portion of the organophosphorus compound from the aqueous medium. Conditions effective to remove at least a portion of the organophosphorus compound from the aqueous medium include, but are not limited to, one or more of the following: contacting at a temperature of 10° C. to 30° C.; contacting for a time of 1 to 48 hours; linear shaking (e.g., at 120 cycles per minute); and flowing through a system in which the organophosphate medium passes through the rare-earth metal-modified carrier (e.g., in a packed column).

The rare-earth metal-modified bio-hydrochar can be contacted with an aqueous medium including the phosphorus compound to remove at least a portion of the phosphorus compound from the aqueous medium. Conditions effective to remove at least a portion of the phosphorus compound from the aqueous medium include, but are not limited to, one or more of the following: contacting at a temperature of 10° C. to 30° C.; contacting for a time of 1 to 48 hours; linear shaking (e.g., at 120 cycles per minute); and flowing through a system in which the organophosphate medium passes through the rare-earth metal-modified bio-hydrochar (e.g., in a packed column).

There are three steps required to produce phosphorus removing composite structures from biomass feedstock. First the biomass is loaded into a reactor, a steel vessel that can withstand high pressure and temperature, and undergoes hydrothermal carbonization (HTC) which produces two product streams: a carbon dense solid called hydrochar, and a liquid stream which contains most of the phosphorus (except in the case of swine manure processing). The second step is to subject the hydrochar to a high temperature thermal treatment, in the absence of oxygen, to open the structure of the material and form a bio-hydrochar. Finally, the bio-hydrochar is mixed with a lanthanum compound and base solution (KOH or NaOH) to precipitate a layer of lanthanum hydroxide on the surface of the bio-hydrochar. A gravity filtration step can be used to separate the composite bio-hydrochar from the solution and after a drying step the bio-hydrochar-lanthanum composite is ready for use.

In some embodiments in which the aqueous medium is in, for example, an agricultural field, conditions effective to remove at least a portion of the phosphorus compound from the aqueous medium include, for example, allowing the aqueous medium to pass through a device containing the rare-earth metal-modified bio-hydrochar. Exemplary devices include, but are not limited to, a permeable bag (e.g., a filter sock) to contain the rare-earth metal-modified bio-hydrochar that allows the aqueous medium to pass through the bag and contact the rare-earth metal-modified bio-hydrochar contained therein. In some embodiments, the device includes a mesh structure. In some embodiments, the device can be laid on the ground along a waterway to treat runoff. In some embodiments, the device can be buried at an optimum depth along sensitive waterways to intercept and sorb the phosphorus compound. The device could be used instead of or in conjunction with a vegetative buffer strip.

In some embodiments, at least 20 percent, at least 40 percent, at least 60 percent, at least 70 percent, at least 80 percent, or at least 90 percent of the phosphorus compound can be removed from an aqueous medium.

In certain embodiments, at least 20 percent, at least 40 percent, at least 60 percent, at least 70 percent, at least 80 percent, or at least 90 percent of the phosphorus compound can be removed from an aqueous medium that also includes phosphorus. In some embodiments, phosphorus can be present in the aqueous medium prior to the contacting step at concentrations equal to or higher (e.g., orders of magnitude higher) than glyphosate.

The present invention is illustrated by the following examples. It is to be understood that the particular examples, materials, amounts, and procedures are to be interpreted broadly in accordance with the scope and spirit of the invention as set forth herein.

### EXAMPLES

### Example 1—Glyphosphate Removal

### Hydrochar and Biochar Production Methods

In the course of this testing corn stover biomass was converted to hydrochar and biochar in separate production processes.

To produce hydrochar the biomass underwent hydrothermal carbonization (HTC) which was performed in either a Parr Series 4520 1 L bench top stirred reactor or a Parr series 4560½ liter reactor (Moline, Ill.). Depending on the biomass solids content, a volume of DI water was added to the reactor along with the biomass to achieve a solids content of 5-10%. Additionally, in situ metal treatments were applied by adding the specific metal chloride and base to the mixture before the reactor is sealed. Unless otherwise noted, all metal chloride treatments discussed were applied with this in situ method. The hydrothermal carbonization treatment was initiated by heating the reactor to the set temperature with a heating mantle, and subsequently maintaining the set temperature for the desired reaction period. The HTC conditions to produce the hydrochars were a reaction temperature of 225° C. held for a 4 hour reaction period beginning when reactor temperature was within 3° C. of set temperature. These conditions resulted in a pressure of 300-500 psi in the sealed reactor. Upon completing the reaction period, the reactor and contents were allowed to cool to room temperature. Two products were collected from the cooled reactor: a solid powder or granular material (hydrochar) and the process water (filtrate). These were separated with vacuum filtration. After the separation, the hydrochar was dried in an oven at 85° C. overnight, while the filtrate was saved in refrigerated storage.

To produce biochar the corn stover biomass was first dried in an oven an 85° C. until completely dry. Then it was placed in crucibles in an inert gas furnace for treatment. The furnace was purged with argon prior to ramping to treatment temperature. Then under continuous argon flow the furnace heats to 600° C. during a ramping period of 3 hours. Once the target temperature is reached the furnace holds at the temperature for 60 minutes, then the furnace is cooled down to room temperature gradually.

### Post Addition Lanthanum Treatment

An alternative method for incorporating lanthanum into a hydrochar or biochar is with post production addition. With this method the dried hydrochar or biochar is mixed with a solution containing lanthanum chloride and potassium hydroxide for a 24 hour period at room temperature. During this 24 hour mixing lanthanum is deposited onto the hydrochar or biochar. At the completion of the mixing period the lanthanum modified solid is separated from the liquid solution with vacuum filtration. One hydrochar and one biochar each underwent this type of lanthanum treatment.

### Experimental Design

A 24-hour batch equilibrium experiment was performed in order to determine if an engineered hydrochar could remove glyphosate from water in the presence of phosphate. The hydrochar tested was derived from corn stover biomass and treated with lanthanum and potassium hydroxide during the hydrothermal carbonization process. Two sets of testing vessels were prepared; the first had additions of the hydrochar and a solution with initial phosphate concentration of 30 ppm and initial glyphosate concentration of 1 ppm. The second set of vessels had the same mass of hydrochar and water with glyphosate concentration of 1 ppm, but with no phosphate present. These concentrations are typical of agricultural waters after applications of phosphate containing fertilizer and glyphosate herbicide to the field. The sample vessels were subsequently placed on a shaker for 24 hours shaking at 120 cycles per minute. At the end of the 24 hour sorption period the concentration of phosphate and glyphosate in the vessels were measured and compared to the initial concentrations.

A second 24-hour batch equilibration experiment was run to determine if other metal chloride and base treatments during the carbonization process could produce a hydrochar capable of removing glyphosate from water. In this set of experiments hydrochars treated with a range of metals and bases were combined with water containing glyphosate only. The hydrochars were combined with water at 1 ppm glyphosate concentration and then shaken for 24 hours. Then the glyphosate concentration was measured to determine how much was removed from the water.

### Experimental Results and Analysis

### Simultaneous Sorption Phenomenon

The first experiment (table 1) yielded the surprising result that the hydrochar could sorb a significant amount of glyphosate from the solution, and that the presence of excess phosphate resulted in only a small reduction in sorption capacity. Specifically, the hydrochar sorbed 0.80 mg glyphosate per gram hydrochar without phosphate present versus 0.71 mg glyphosate per gram hydrochar in the presence of phosphate. The second result, 0.71 mg, was in water which had a phosphate concentration of 13 ppm remaining. Based on previous research it would be expected that the excess phosphate in solution would replace the glyphosate and reduce the glyphosate sorption to zero. That was not the result in this experiment, which indicates that the mechanism of glyphosate sorption is simultaneous and essentially non-competitive with phosphate sorption.

### Specific Base Utilized.

The second experiment (table 2) showed that the lanthanum and potassium hydroxide treatment significantly outperformed other treatments. To determine if lanthanum with any base would result in similar performance, a hydrochar was produced with lanthanum and sodium hydroxide instead of potassium hydroxide. The resulting hydrochar had approximately 20% of the capacity to sorb glyphosate from water.

### Function of Activating Metal

Additionally metals other than lanthanum were tested, see table 2. Hydrochars were produced with magnesium or iron instead of lanthanum to determine if lanthanum was the preferred metal. The hydrochar produced with magnesium has approximately 15% of the capacity to sorb glyphosate from water as compared to that made with lanthanum, while the hydrochar produced with iron had 50% of the capacity to sorb glyphosate. Follow up testing with the Iron hydrochar in the presence of both glyphosate and phosphate resulted in a sorption rate of 13%, versus the lanthanum hydrochar sorption rate of 71%, see table 3. Therefore, in the presence of phosphate the lanthanum char was 5 times more effective to adsorb glyphosate. These results show that the specific combination of lanthanum and potassium hydroxide is required for the most effective glyphosate sorption from water, especially in the presence of phosphate.

### Method of Lanthanum Addition

Two methods of lanthanum addition were applied to corn stover derived hydrochars: in situ and post-HTC addition with KOH in both cases as the base. When introduced to a 1 ppm solution of glyphosate each lanthanum modified char had a capacity to adsorb 92% of the glyphosate, see table 4. These results indicate that either method of lanthanum addition is effective to increase glyphosate sorption.

### Post Thermal Treatment (PTT) of Lanthanum Modified Hydrochar to Increase Surface Area

A hydrochar which had undergone in situ lanthanum addition was further conditioned in an inert gas furnace to increase its surface area, and subsequently tested to quantify the improvement in glyphosate sorption capacity. It was found that the hydrochar has a 30% higher glyphosate sorption capacity following the treatment, see table 5. However, during the additional treatment approximately half of the hydrochar's mass is lost which reduces the total hydrochar produced from a given amount of starting biomass. The 30% improvement in sorption capacity is not high enough to merit this additional treatment given the lower yield and additional energy requirements.

Performance of Biochar with and without Lanthanum Addition

Corn stover derived biochar was produced and subsequently underwent post addition lanthanum treatment to evaluate the glyphosate sorption of biochar with and without lanthanum treatment. It was found that biochar with lanthanum addition was able to adsorb 20× more glyphosate than biochar without treatment on a per mass basis, see table 6.

### Performance of Lanthanum Treated Hydrochar to Adsorb Diazinon

It has been demonstrated that a lanthanum treated hydrochar can adsorb glyphosate, which is an organophosphate pesticide, from water. Additional testing was performed to determine if this same hydrochar has the ability to adsorb Diazinon, which is a different organophosphate pesticide. It was found that lanthanum treatment either had no effect or a negative effect on the ability of a hydrochar to adsorb Diazinon, see table 7. This result suggests that the improvement in pesticide sorption capacity from lanthanum treatment may be limited to glyphosate and not apply to other organophosphate pesticides with different surface chemistries.

### CONCLUSION

This corn stover derived modified hydrochar appears to have a unique and unexpected capacity to simultaneously adsorb phosphate and glyphosate from water, as demonstrated by the experiments outlined above.

Further experiments have been performed that indicate lanthanum combined with potassium hydroxide treatment has a greater effect on a hydrochar to increase glyphosate sorption capacity versus other metal or base combinations. Testing has been completed that shows the lanthanum and potassium hydroxide treatment is effective either during the HTC process (in situ) or after the process with post addition. Experiments with a corn stover derived biochar, rather than a hydrochar, indicate that the lanthanum and potassium hydroxide post addition treatment is also effective for biochar. The lanthanum treated hydrochar was evaluated for Diazinon sorption capacity to determine if other organophosphate pesticides could be captured with this hydrochar, but the lanthanum treatment appears to have either no effect or a negative effect on sorption of the Diazinon pesticide.

### Tabulated Results

The capacity of each hydrochar or biochar to adsorb glyphosate is reported in the far right column as percent of glyphosate removed from solution (%) and additionally as the mass captured normalized by the mass of hydrochar/biochar used. (mg glyphosate/g hydrochar or g biochar) or (mg/g)

TABLE 1
Simultaneous Glyphosate and Phosphate Sorption Results for La + KOH
Treated Hydrochar

| | Run Description | | | | |
|---|---|---|---|---|---|
| | Initial | Final | Initial | Final | Total |
| | phosphate | phosphate | glyphosate | glyphosate | glyphosate |
| | concentration | concentration | concentration | concentration | sorption |
| | units | | | | |
| | ppm | ppm | ppm | ppm | |
| | PO₄³⁻-P | PO₄³⁻-P | glyphosate | glyphosate | % (mg/g) |
| Glyphosate | 0 | 0 | 1.0 | 0.20 | 80 (0.8) |
| only | | | | | |
| Glyphosate | 30.0 | 12.9 | 1.0 | 0.29 | 71 (0.71) |
| and | | | | | |
| phosphate | | | | | |

TABLE 2
Glyphosate Sorption Comparison of Hydrochars Treated with Metals and
Bases (no phosphate)

| | Hydrochar Description | | | | |
|---|---|---|---|---|---|
| | | | Initial | Final | Total |
| | | Base | glyphosate | glyphosate | glyphosate |
| | Metal used | used | concentration | concentration | sorption |
| | units | | | | |
| | | | ppm | ppm | |
| | — | — | glyphosate | glyphosate | % (mg/g) |
| Standard La and KOH | Lanthanum | KOH | 1.0 | 0.08 | 92 (0.092) |
| Lanthanum with NaOH | Lanthanum | NaOH | 1.0 | 0.83 | 17 (0.017) |
| instead of KOH | | | | | |
| Magnesium instead of | Magnesium | KOH | 1.0 | 0.85 | 15 (0.015) |
| lanthanum, with KOH | | | | | |
| Iron instead of | Iron | KOH | 1.0 | 0.49 | 51 (0.051) |
| lanthanum, with KOH | | | | | |

TABLE 3
Glyphosate Sorption Comparison between Lanthanum Hydrochar and
Iron Hydrochar in the presence of 30 ppm phosphate

| | Hydrochar Description | | | | |
|---|---|---|---|---|---|
| | | | Initial | Final | Total |
| | | Base | glyphosate | glyphosate | glyphosate |
| | Metal used | used | concentration | concentration | sorption |
| | units | | | | |
| | | | ppm | ppm | |
| | — | — | glyphosate | glyphosate | % (mg/g) |
| Standard La and KOH | Lanthanum | KOH | 1.0 | 0.31 | 71 (0.71) |
| Iron instead of | Iron | KOH | 1.0 | 0.87 | 13 (0.13) |
| lanthanum, with KOH | | | | | |

TABLE 4
Hydrochar with “in situ” versus “post” lanthanum addition (no phosphate)

| | Hydrochar Description | | | | |
|---|---|---|---|---|---|
| | | | Initial | Final | Total |
| | | Base | glyphosate | glyphosate | glyphosate |
| | Metal used | used | concentration | concentration | sorption |
| | units | | | | |
| | | | ppm | ppm | |
| | — | — | glyphosate | glyphosate | % (mg/g) |
| Standard La and KOH | Lanthanum | KOH | 1.0 | 0.08 | 92 (0.092) |
| in situ addition | | | | | |
| Post La addition on | Lanthanum | KOH | 1.0 | 0.08 | 92 (0.092) |
| stover hydrochar | | | | | |

TABLE 5
Glyphosate sorption capacity of Lanthanum Hydrochar with and
without additional post-HTC thermal treatment (PTT) to increase
surface area (in the presence of 30 ppm phosphate).

| | | | | Initial | Final | Total |
|---|---|---|---|---|---|---|
| Hydrochar | | Base | PTT | glyphosate | glyphosate | glyphosate |
| Description | Metal used | used | Used | concentration | concentration | sorption |
| units | — | — | | ppm | ppm | % (mg/g) |
| | | | | glyphosate | glyphosate | |
| Standard La | Lanthanum | KOH | No | 1.0 | 0.29 | 71 |
| and KOH | | | | | | (0.71) |
| Standard La | Lanthanum | KOH | Yes | 1.0 | 0.09 | 91 |
| and KOH then | | | | | | (0.91) |
| PTT | | | | | | |

TABLE 6
Glyphosate Sorption Capacity of a Corn Stover derived Biochar with and
without Lanthanum in solution with 30 ppm PO₄³⁻

| | Biochar Description | | | | |
|---|---|---|---|---|---|
| | | | Initial | Final | Total |
| | | Base | glyphosate | glyphosate | glyphosate |
| | Metal used | used | concentration | concentration | sorption |
| | units | | | | |
| | | | ppm | ppm | |
| | — | — | glyphosate | glyphosate | % (mg/g) |
| Biochar from Stover | — | — | 1.0 | 0.62 | 40 (0.04) |
| Biochar from stover, | Lanthanum | KOH | 1.0 | 0.13 | 87 (0.87) |
| with | | | | | |
| Lanthanum + KOH | | | | | |
| addition | | | | | |

TABLE 7
Diazinon Sorption Capacity of Hydrochar with and without Lanthanum,
and Filtrasorb 400

| | Hydrochar Description | | | | |
|---|---|---|---|---|---|
| | | | Initial | Final | Total |
| | | Base | Diazinon | Diazinon | Diazinon |
| | Metal used | used | concentration | concentration | sorption |
| | units | | | | |
| | | | ppm | ppm | |
| | — | — | Diazinon | Diazinon | % (mg/g) |
| Stover hydrochar - no | — | — | 1.0 | 0.39 | 61 (0.061) |
| treatment | | | | | |
| La and KOH treatment | Lanthanum | KOH | 1.0 | 0.62 | 38 (0.038) |
| of stover hydrochar | | | | | |

### Example 2—Phosphate Removal

### Hydrothermal Carbonization (HTC)

To produce hydrochar the biomass underwent hydrothermal carbonization (HTC) which was performed in a Parr Series 4520 1 L bench top stirred reactor (Moline, Ill.). Depending on the biomass solids content, a volume of DI water was added to the reactor along with the biomass to achieve a solids content of 5-10%. The hydrothermal carbonization treatment was initiated by heating the reactor to the set temperature with a heating mantle, and subsequently maintaining the set temperature for the desired reaction period. The HTC conditions to produce the hydrochars were either a reaction temperature of 250° C. held for a 2 hour reaction period for corn stover or 225° C. for 2 hours for cattle, swine, and poultry manures. See table 1. In each case the reaction time started when reactor temperature was within 3° C. of set temperature. These conditions resulted in a pressure of 300-500 psi in the sealed reactor. Upon completing the reaction period, the reactor and contents were allowed to cool to room temperature. Two products were collected from the cooled reactor: a solid hydrophobic powder or granular material (hydrochar) and the process water (filtrate). These were separated with vacuum filtration. After the separation, the hydrochar was dried in an oven at 85° C. overnight, while the filtrate was saved in refrigerated storage.

TABLE 1
HTC Reaction Conditions

| | | Cattle | Swine | Poultry |
|---|---|---|---|---|
| Feedstock | Corn Stover | Manure | Manure | Manure |
| Reaction Time | 4 hours | 2 hours | 2 hours | 2 hours |
| Reaction | 250° C. | 225° C. | 225° C. | 225° C. |
| Temp. | | | | |

### Post-HTC Thermal Treatment (PTT)

Dried hydrochar from the previous step is placed in ceramic crucibles and loaded into an inert gas furnace. The furnace is sealed and purged with argon three times. Then under continuous argon flow the furnace ramps to a final treatment temperature of 600° C. with a 3-hour ramping period. The furnace holds at 600° C. for 1 hour and then gradually is allowed to cool to room temperature. Finally, the bio-hydrochar is collected from the furnace and stored.

### Post-Treatment Lanthanum Hydroxide Addition

The dried bio-hydrochar, which has undergone PTT, is combined with a solution of lanthanum compound and base in a glass vial. The solution and bio-hydrochar are mixed for 24 hours to allow the lanthanum hydroxide to effectively coat the material. At the completion of the mixing period the lanthanum coated bio-hydrochar is separated from the solution with vacuum filtration and dried. Then the bio-hydrochar composite can be stored and is ready to be used to remove phosphate from solution.

This three-step method has been optimized through many iterations and has been determined to be the most effective process for production of a bio-hydrochar-lanthanum composite for phosphorus removal.

### 1 Step Production Method

We have found that the three-step production method described above is not necessary to convert dry biomass, such as corn stover, to a lanthanum-composite material for removing phosphorus from solution. A simple 1-step method has been utilized to apply lanthanum hydroxide directly to raw untreated corn stover. In this case raw corn stover is combined with solution to complete only step 3 from the three-step process detailed above.

### Post-Treatment Lanthanum Hydroxide Addition

Untreated corn stover is combined with a solution of lanthanum compound and base in a glass vial. The solution and stover are mixed for 24 hours to allow the lanthanum hydroxide to effectively coat the material. At the completion of the mixing period the lanthanum coated stover is separated from the solution with vacuum filtration and dried. Then the stover-lanthanum composite can be stored and is ready to be used to remove phosphate from solution.

### Evaluation of Phosphorus Removal Performance

### Experimental Procedure

A 24 hour batch equilibrium phosphate removal test was conducted to evaluate the ability for the hydrochars to remove phosphate from water. A small sample of bio-hydrochar composite is combined with a 50 ppm PO₄-P challenge solution and mixed for 24 hours. At the conclusion of the mixing period the solid material is filtered out of the solution and the amount of phosphorus remaining in solution is measured. Once the ending phosphorus concentration is determined the capacity of the composite to remove phosphate from solution can be calculated. This capacity is then normalized to the units of mg phosphorus removed per 1 gram of composite. The capacity for a material to remove phosphorus from water is the key performance parameter.

### Results and Analysis

Bio-hydrochar materials were produced from four feedstocks which are each widely available and inexpensive agricultural residues. These feedstocks were corn stover and manure from cattle, swine, and poultry. Each feedstock was treated with the three-step method described above in the production method section. Then the materials were evaluated with the 24-hour batch phosphorus removal test described above. The following table summarizes the calculated phosphorus removal capacities for the materials derived from each of the four feedstocks.

TABLE 2
Phosphorus Removal Capacity of bio-hydrochars Produced with
3 Step Method, 24 hours

| | Starting Biomass | | |
|---|---|---|---|
| | Starting P | | Phosphorus Removal |
| | Conc. | Ending P Conc. | Capacity |
| | units | | |
| | ppm PO₄-P | ppm PO₄-P | (mg PO₄-P)/(g material) |
| Corn Stover | 50.0 | 6.7 | 43.3 |
| Cattle Manure | 50.0 | 7.8 | 42.3 |
| Poultry Manure | 50.0 | 17.9 | 32.0 |
| Swine Manure* | 50.0 | 15.6 | 34.4 |

*Swine manure required an intermediate acid washing step before PTT to be effective

All four materials achieved phosphorus removal in the range of 32-43 mg of phosphorus per gram of composite after undergoing the 3-step method. The materials derived from corn stover and cattle manure were found to be the most effective with these test conditions as they each reached a removal capacity of greater than 40 mgP per gram composite material.

TABLE 3
Phosphorus Removal Capacity of Untreated Stover with 1 Step
Method, 24 hours

| | Starting Biomass | | |
|---|---|---|---|
| | Starting P | | Phosphorus Removal |
| | Conc. | Ending P Conc. | Capacity |
| | units | | |
| | ppm PO₄-P | ppm PO₄-P | (mg PO₄-P)/(g material) |
| Corn Stover | 50.0 | 25.1 | 24.8 |

The corn stover composite produced with the 1 step method achieves a 42% lower removal capacity than the stover composite which underwent the more complex 3 step process.

### Asymptotic Equilibrium Removal Values

The results above were obtained with a simple 24-hour phosphate test for all materials evaluated. It must be kept in mind that given longer contact time the materials have been found to remove a greater amount of phosphorus from the water until equilibrium is achieved based on the lanthanum content of the particular composite. A limited number of materials have been tested with a week-long (168 hours) contact time rather than 24 hours and the removal capacity was observed to increase to an equilibrium or asymptotic level.

### Extended Contact Time Experiment

An additional test was run with a contact time of one week to determine the maximum phosphate removal that select materials were capable of achieving. The lower performing raw stover material with the 1 step method was of particular interest due to the performance with the 24 hour contact time experiment. Tables 4 and 5 show the results for phosphate removal over 1 week, or 168 hours for materials with either the 3-step method (table 4) or the 1 step method (table 5).

TABLE 4
Phosphorus Removal Capacity of Hydrochars Produced with
3 Step Method, 168 hours

| | Starting Biomass | | |
|---|---|---|---|
| | Starting P | | Phosphorus Removal |
| | Conc. | Ending P Conc. | Capacity |
| | units | | |
| | ppm PO₄-P | ppm PO₄-P | (mg PO₄-P)/(g material) |
| Corn Stover | 60.0 | 7.9 | 52.1 |
| Cattle Manure | 60.0 | 14.2 | 45.9 |

TABLE 5
Phosphorus Removal Capacity of Untreated Stover with
1 Step Method, 168 hours

| | Starting Biomass | | |
|---|---|---|---|
| | Starting P | | Phosphorus Removal |
| | Conc. | Ending P Conc. | Capacity |
| | units | | |
| | ppm PO₄-P | ppm PO₄-P | (mg PO₄-P)/(g material) |
| Corn Stover | 60.0 | 19.5 | 40.6 |

Comparing the results from tables 4 and 5 to those from table 2 and 3 we can see that phosphorus removal capacity increased for all three materials tested. The increase in phosphate removal capacity was greatest with the material produced from raw corn stover with the 1 step method. These results suggest that the 3-step method of converting the biomass to a bio-hydrochar produces a material which removes phosphate at a faster rate than those produced with the 1 step method. Given a long contact time, materials produced with either method may have similar final phosphorus removal capacity.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method for removing phosphorus compounds from an aqueous medium, the method comprising:
providing a rare-earth metal-modified carrier; and
contacting the rare-earth metal-modified carrier with an aqueous medium comprising the phosphorus compound under conditions effective to remove at least a portion of the phosphorus compound from the aqueous medium.

2. The method of claim 1, wherein the phosphorus compound is a phosphate.

3. The method of claim 1, wherein the phosphorus compound is glyphosate.

4. The method of claim 3, wherein the aqueous medium comprises, prior to the contacting step, 0.1 ppb to 10 ppm glyphosate.

5. The method of claim 2, wherein the aqueous medium comprises, prior to the contacting step, 0.1 ppm to 100 ppm phosphate.

6. The method of claim 1, wherein the rare-earth modified carrier is selected from ceramic beads, sand, zeolites, corn stover, biochar, a hydrochar, a bio-hydrochar, or combinations thereof.

7. The method of claim 1, wherein providing the rare-earth metal-modified carrier comprises subjecting a biomass, a hydrochar, a biochar, or combinations thereof to a treatment in the presence of a rare-earth metal salt and a hydroxide under conditions effective to produce the rare-earth metal-modified carrier.

8. The method of claim 7, wherein the rare-earth metal salt is selected from the group consisting of rare-earth metal halides, rare-earth metal nitrates, and combinations thereof.

9. The method of claim 8, wherein the rare-earth metal halide is a lanthanum halide.

10. The method of claim 9, wherein the lanthanum halide is lanthanum chloride.

11. The method of claim 8, wherein the rare-earth metal nitrate is lanthanum nitrate.

12. The method of claim 7, wherein the hydroxide is selected from the group consisting of sodium hydroxide, potassium hydroxide, and combinations thereof.

13. The method of claim 1, wherein providing the rare-earth metal-modified carrier comprises treating a hydrochar with a solution of a rare-earth metal salt and a hydroxide under conditions effective to produce a rare-earth metal-modified bio-hydrochar.

14. The method of claim 1, wherein providing the rare-earth metal-modified carrier comprises treating a biochar with a solution of a rare-earth metal salt and a hydroxide under conditions effective to produce a rare-earth metal-modified biochar.

15. The method of claim 1, wherein at least 20 percent of the phosphorus compound is removed from the aqueous medium.

16. A method for removing phosphorus compounds from an aqueous medium, the method comprising:
subjecting a biomass, a hydrochar, a biochar, or combinations thereof to a treatment in the presence of a rare-earth metal salt and a hydroxide to provide a rare-earth metal-modified carrier; and
contacting the rare-earth metal-modified carrier with an aqueous medium comprising the phosphorus compound under conditions effective to remove at least a portion of the phosphorus compound from the aqueous medium.

17. The method of claim 16, wherein the treatment comprises subjecting a biomass to hydrothermal carbonization in the presence of a rare-earth metal salt and a hydroxide under conditions effective to produce a rare-earth metal-modified hydrochar.

18. The method of claim 16, wherein the treatment comprises treating a hydrochar with a solution of a rare-earth metal salt and a hydroxide under conditions effective to produce the rare-earth metal-modified hydrochar.

19. The method of claim 18, wherein the treatment further comprises treating the rare-earth metal-modified hydrochar with a high temperature thermal treatment in the absence of oxygen.
